(19) United States
(12) Patent Application Publication
(10) Pub. No.: US 2013/0159092 A1
(43) Pub. Date: Jun. 20, 2013

(54) SYSTEM AND METHOD FOR EFFICIENT RANKING IN ONLINE ADVERTISING BY SHAPING RELEVANCE SCORES

(71) Applicants: Sebastien Lahaie, Greenwich, CT (US); R. Preston McAfee, San Marino, CA (US)

(72) Inventors: Sebastien Lahaie, Greenwich, CT (US); R. Preston McAfee, San Marino, CA (US)

(73) Assignee: YAHOO! INC., Sunnyvale, CA (US)

(21) Appl. No.: 13/329,456

(22) Filed: Dec. 19, 2011

(51) Int. Cl. G06Q 30/02

(52) U.S. Cl. 705/14.45

(57) ABSTRACT

The present invention is directed towards a method and system for ranking advertisements in an auction-based advertising system. The method of the present system comprises receiving one or more search queries and selecting one or more keywords from the one or more search queries. One or more bids associated with a given keyword selected from the one or more search queries are retrieved and a priority score for one or more advertisements is determined, wherein each of the one or more advertisements is associated with a given bid. The priority score is determined by taking the product of a position normalized click through rate associated with a given advertisement adjusted by an exponential value and the given bid. The one or more advertisements are then ranked according to the priority score.

### CROSS REFERENCE TO RELATED APPLICATIONS

The present application is related to the following co-owned U.S. patent application:

U.S. patent application Ser. No. 11/760,069, entitled “SYSTEM AND METHOD FOR SHAPING RELEVANCE SCORES FOR POSITION AUCTIONS,” filed on Jun. 8, 2007 and published as U.S. Patent Publication No. 2008/0306819, the disclosures of which is hereby incorporated by reference herein in their entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention described herein generally relates to shaping relevance scores for position auctions. More specifically, the present invention is directed to systems and methods for shaping relevance scores based on the uncertainty in the estimated click-through rate (CTR) of advertisements.

### BACKGROUND OF THE INVENTION

Search engines serve as advertisement providers and generate revenue by auctioning advertising space on keyword search result pages. A common technique that advertisement providers use is that of a position auction. When a user searches for keywords in a corpus of documents, the results are returned to along with relevant advertisements. In a position auction, advertisers submit bids corresponding to desired keywords. After advertisers submit bids and corresponding advertisements, the advertisement provider ranks the advertisements to determine an appropriate order or position for presentation of the advertisements to the user.

A technique that is used to rank advertisements in position auctions is one which takes into account a relevance or quality score for the advertisements. That is an advertiser determines a rank for a given advertisement by taking the product of the bid for the advertisement and the determined relevance score for the advertisement. The relevance score depends in large part on the advertisement's estimated click-through rate (CTR). However, the current techniques that utilize this ranking methodology fail to take into account uncertainties in CTR estimates, such as when there exists a dearth in the historical click data. By failing to take into account such uncertainties in CTR estimates, the efficiency of the position auction becomes compromised, which results in diminished overall advertiser satisfaction.

Accordingly there exists a need to incorporate uncertainties in CTR estimates in determining advertisement rankings so as to create a more efficient auction-based online advertising system and consequently improve overall advertiser satisfaction.

### SUMMARY OF THE INVENTION

The present invention is directed towards systems and methods for ranking advertisements in an auction advertising system. The method of the present system comprises receiving one or more search queries and selecting one or more keywords from the one or more search queries. One or more bids associated with a given keyword selected from the one or more search queries are retrieved and a priority score for one or more advertisements is determined, wherein each of the one or more advertisements is associated with a given bid. The priority score is determined by taking the product of a position normalized click through rate associated with a given advertisement adjusted by an exponential value and the given bid. The one or more advertisements are then ranked according to the priority score.

The present invention is further directed towards a system for ranking advertisements in an auction advertising system. The system comprises a network communicatively coupled to one or more user devices and one or more advertiser devices. A content server is further coupled to said network and comprises a query analyzer, an ad generator and a rank generator. The query analyzer is operative to receive one or more search queries from the one or more user devices and select one or more keywords from the one or more search queries. The ad generator is operative to generate or otherwise select one or more advertisements corresponding to a search query. The rank generator is operative to retrieve one or more bids associated with a given keyword selected from the one or more search queries, determine a priority score for the one or more advertisements, wherein each of the one or more advertisements is associated with a given bid, the priority score determined by taking the product of a position normalized click through rate associated with a given advertisement adjusted by an exponential value and the given bid, and rank the one or more advertisements according to the priority score.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 presents a system for ranking and providing advertisements in a position auction according to an embodiment of the present invention; and

FIG. 2 presents a method for ranking and providing advertisements in a position auction according to an embodiment of the present invention.

### DETAILED DESCRIPTION OF THE INVENTION

In the following description of the embodiments of the invention, reference is made to the accompanying drawings that form a part hereof, and in which is shown by way of illustration, exemplary embodiments in which the invention may be practiced. It is to be understood that other embodiments may be utilized and structural changes may be made without departing from the scope of the present invention.

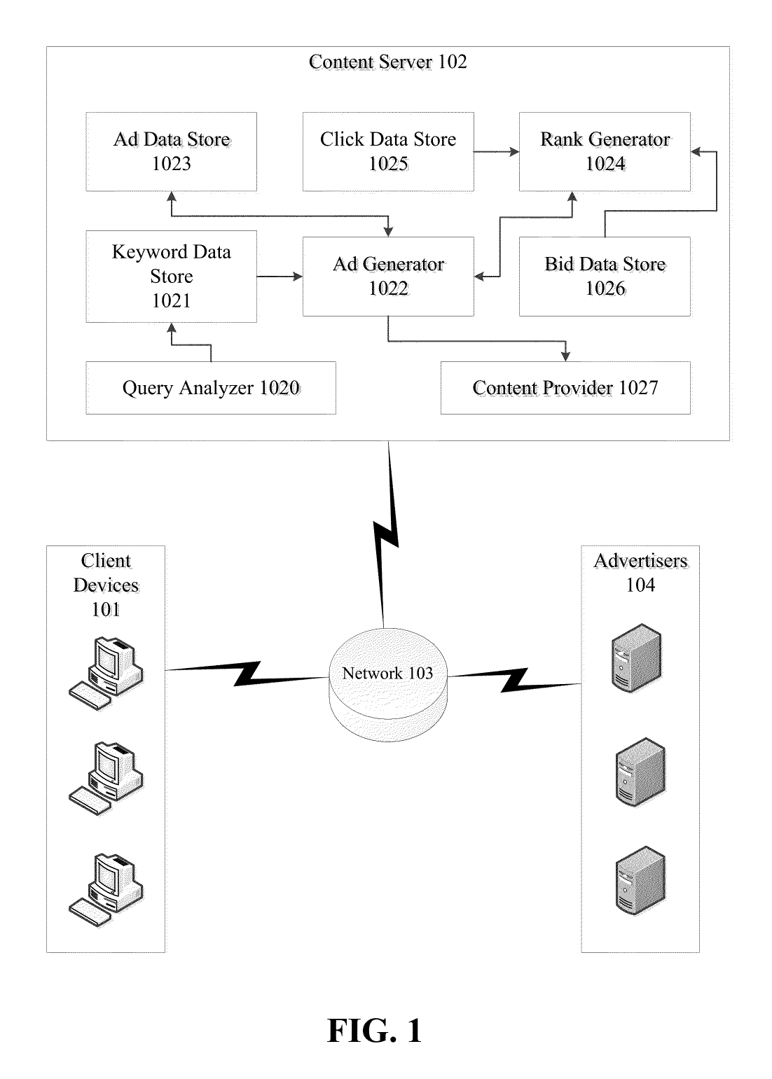

FIG. 1 presents a block diagram depicting one embodiment of a system for shaping relevance scores for position auctions. According to the embodiment illustrated in FIG. 1, a system for shaping relevance scores for position auctions comprises one or more client devices 101, one or more advertisers 104, a content server 102 and a network 103.

According to the embodiment illustrated in FIG. 1, client device 101 is communicatively coupled to a network 103, which may include a connection to one or more local and wide area networks, such as the Internet. According to one embodiment of the invention, client device 101 is a general purpose personal computer comprising a processor, transient and persistent storage devices operable to execute software such as a web browser, peripheral devices (input/output, CD-ROM, USB, etc.) and a network interface. Other client devices are considered to fall within the scope of the present invention including, but not limited to, hand held devices, set top terminals, mobile handsets, PDAs, etc. Network 103 may be any suitable type of network allowing transport of data communications across thereof. In one embodiment, the network may be the Internet, following known Internet protocols for data communication, or any other communication network, e.g., any local area network (LAN), or wide area network (WAN) connection.

Advertiser 104 is communicatively coupled to the network 103 and may comprise one or more processing components disposed on one or more processing devices or systems in the networked environment. Content server 102 is also communicatively coupled to network 103 and is operative to receive data from client devices 101 and advertisers 104. In one embodiment, the content server 102 is operative to receive search queries from client devices 101. Search queries may be in the form of text strings, e.g., keywords, which a user may enter into an HTML form element such as a text box. Content server 102 may further be operative to return search results to client 110, as well as advertisements. In addition to communicating with the client devices 101, content server 102 may be further operative to communicate with advertiser 104. In one embodiment, the content server 102 may be operative to receive bid information for a search keyword from one or more advertisers 104. Additionally, content server 102 may be operative to return statistical data regarding an advertisement to said advertiser. In alternative embodiments, the content server 102 may be operative to communicate other relevant data to and receive other relevant data from one or more advertisers 104, including, but not limited to, billing information, analytics information and any other relevant information known in the art.

Content server 102 comprises a query analyzer 1020, keyword data store 1021, ad generator 1022, ad data store 1023, rank generator 1024, click data store 1025, bid data store 1026, and content provider 1027. Advertiser 104 places a bid by submitting a bid request to content server 102. A bid corresponds to a willingness to pay a monetary amount per user interaction, such as a user click. In one embodiment, the content server 102 provides a list of available keywords stored in keyword data store 1021. Alternatively, the advertiser 104 may be able to select keywords not present in keyword data store 1021. After the advertiser 104 selects the desired keywords, a bid is submitted and stored within bid data store 1026.

After a keyword is selected by the advertiser 104, a corresponding advertisement is selected by the advertiser 104 and submitted to the content server 102 for storage within an advertisement data store 1023. In accordance with some embodiments, an advertisement that the advertiser 104 submits may be a textual advertisement comprising a product title, brief product description and a URL containing the product details. In alternative embodiments, the advertiser 104 may submit advertisements that comprise graphical information, audio information, video information or any advertising medium known to those of skill in the art.

When a user submits a query using a web search engine, query analyzer 1020 receives the search query from the user. Query analyzer 1020 may determine the keywords contained within a received user query. For example, if a user enters the query “Yankees tickets”, query analyzer 1020 may determine the query contains two keywords, the team “Yankees” and the object “tickets.” Query analyzer 1020 determines keywords that a query contains by querying keyword data store 1021. Determining groups of semantically related terms from a query comprising one or more keywords may be conducted in accordance with the systems and methods described in commonly owned U.S. Pat. No. 7,051,023, entitled “SYSTEMS AND METHODS FOR GENERATING CONCEPT UNITS FROM SEARCH QUERIES,” filed on Nov. 12, 2003, the disclosure of which is hereby incorporated by reference herein in its entirety. If a match is found within the keyword data store 1021, the match is forwarded to ad generator 1022.

After ad generator 1022 receives the keywords, the ad data store 1023 is queried for advertisements corresponding to or otherwise matching the extracted keywords. In one embodiment, the advertisements stored within ad data store 1023 may comprise textual advertisements containing an advertisement title (such as “Buy Cheap Yankees Tickets”), a description supplementing the title (such as “Buy New York Yankees Tickets. But Now & Save 10% or More.”) and a URL associated with the advertisement (such as “www.TicketLiquidator.com”). Ad data store 1023 may also maintain other advertisement media known to those of skill in the art.

Once advertisements corresponding to the received keywords are retrieved, rank generator 1024 may order the advertisements by a priority score. According to one embodiment, the rank generator 1024 receives the keyword from the ad generator 1022 and retrieves a bid list from bid data store 1026. Rank generator 1024 receives a list of advertisers bidding on a selected keyword and proceeds to determine a priority score for a given advertisement. Techniques for calculating the priority score in accordance with various embodiments of the invention are described in greater detail herein.

Rank generator 1024 is further communicatively coupled to click data store 1025. Rank generator 1024 receives click rate data from click data store 1025. Click data store 1025 contains information relating to user interaction with one or more advertisements. In accordance with one embodiment, click rate data for a given advertisement may comprise a function of the number of impressions for a given advertisement and the number of times one or more users have clicked on the given advertisement in response to an impression for the given advertisement, which may be recorded whenever a user interacts with the given advertisement. In accordance with one embodiment, whenever a user clicks on a given advertisement hyperlink, data is returned to the content provider for storage in the click data store 1025 indicating that a user has selected the given advertisement. In turn, a counter is incremented indicating another user has selected the advertisement. Impression data is also returned to the click data store 1025 in response to the display of an advertisement to a user. Alternative embodiments may exist wherein additional data is collected in lieu of or in conjunction with the preceding example. Techniques for collecting information regarding advertisement impression and selection are well known to those of skill in the art.

In accordance with one embodiment, the priority score of a given advertisement corresponds to the price of the bid multiplied by a function whose input is the quality score an advertisement received, as illustrated in Equation 1.

Priority score=Bid*f(quality score) Equation 1

The quality score may be a measure of the “clickability” or “relevance” for the given advertisement. According to one embodiment, the priority score is based on an estimated position-normalized CTR adjusted for uncertainty in the historical click rate data as illustrated in Equation 2,

f(quality score)=e^{γ} Equation 2

where e is the estimated position-normalized CTR and γ represents a weight on the estimated position-normalized CTR according to the certainty of the estimate, which may be represented by a convex combination between it and the prior mean. According to one embodiment, the estimated position-normalized CTR (e) for a given advertisement represents the number of clicks for the given advertisement per number of searches and the position effect for the given advertisement. The position effect of an advertisement takes into account where an advertisement was placed on a web page as compared to where a competitor's advertisement was placed or positioned on the same web page. For example, an advertisement placed at a third rank in a side portion of the web page where there exists two competitor ads ranked first and second but placed on the top portions of the web page will command more attention from the user as compared to an advertisement being ranked third and placed on the side portion where there are no advertisements on the top portion of the page, i.e. the advertisement is positioned third on the side of the web page. The estimated position-normalized CTR can be represented by the following:

e=Number of clicks/(Number of searches*Position Effect)

According to one embodiment, the priority score for an advertisement is determined by taking the estimated position-normalized CTR and applying an exponential adjustment, γ, which represents a weight on the estimated position-normalized CTR according to the certainty of the estimate. The exponential adjustment, γ, is optimized in order to achieve advertiser satisfaction. In order to determine the optimal γ, a hierarchal Bayesian model of estimated position-normalized CTRs is developed for individual keywords. For a given keyword, unit i corresponds to an ad-position pair with j[i] as the ad in unit i. The position-normalized CTR e is denoted as γᵢ in the following one-way hierarchal model,

log yᵢ˜N(α_{j[i]},σ_{y}²)

αᵢ˜N(μ_{α},σ_{α}²)

where i ranges over all units and j over all the ads, and N refers to the distribution. According to one embodiment, N refers to the normal distribution, but other distribution models may be used. Uniform prior values are used as part of the model where αⱼ corresponds to the intercept, μl_{α} denotes the mean value and σ denotes variance. Using the hierarchal model, γ can be set by Equation 3 as follows,

$$γ = \frac{{V}_{j} E [ {ɛ}_{j} ]}{E [ {V}_{j} {ɛ}_{j} ]} \qquad Equation 3$$

where εⱼ=αⱼ−μ_{α}, V represents the finite sample variance operator defined by

$${V}_{j} {ɛ}_{j} = \frac{1}{n - 1} {\sum }_{j} ( {ɛ}_{j} - {\overline{ɛ}}_{j} ) ,$$

and E is the finite sample mean. The denominator of Equation 3 may be viewed as the unexplained component of the variance among the αⱼ's, while the numerator is the variance among the point estimates of the εⱼ's. According to one embodiment, a value for γ is a value between zero (0) and (1), where a value for γ is closer to one (1) if the numerator is large relative to the denominator, i.e. the αⱼ lies closer to the empirical mean of the position-normalized CTR, while a value for γ will be closer to zero (0) when the denominator is large relative to the numerator, i.e. the αⱼ lies closer to μⱼ so that the prior mean is given a higher weight.

Referring to FIG. 1, the rank generator 1024 orders the advertisements by priority score and one or more of the ordered advertisements are selected for display to the user. The number of advertisements that the rank generator 1024 selects may correspond to the number of free advertising slots available on a website, e.g., a search result page that a search engine produces. It should be noted by those of skill in the art that embodiments of the present invention are not limited to placement of ranked advertisements on a search result page and may be applicable to any systems that utilize ranked lists of items in which users pay for placement of items in the list, e.g., a real estate listing site, personals/dating site, etc.

Advertisements and slot positions may be sent to content provider 1027. Content provider 1027 may be operative to combine the advertisements with the data in the query result set, returning the combined resource to clients 101 across the network 103.

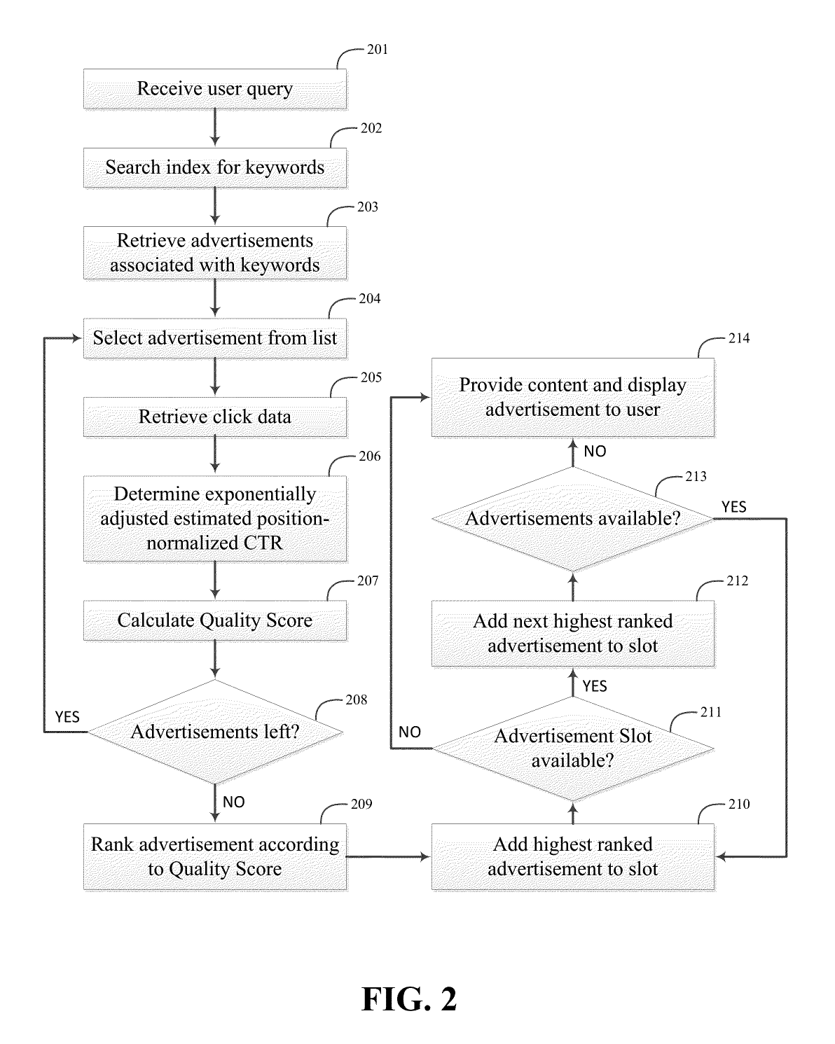

FIG. 2 is a flow diagram illustrating one embodiment of a method for dynamically ranking and providing advertisements in a position auction. A user query is received, step 201, which may correspond to the search terms requested of a search engine, such as through an HTML text box. After a user query is received, an index is searched for corresponding keywords, step 202. For example, if an index of keywords contains the terms “Yankees”, “tickets”, “baseball”, and “New York” and a user query comprises “Yankees tickets”, the keywords “Yankees” and “tickets” will be extracted from the user query. The extraction of keywords from a given user query may be performed in accordance with the systems and methods described in the applications previously incorporated herein by reference in their entirety. Extracted keywords may attempt to represent a user query with a minimal dictionary of terms understandable by a server system.

After at least one keyword is extracted from the user query, a list of advertisements corresponding to the keyword are retrieved, step 203. Given a list of advertisements, a first advertisement is selected from the list of advertisements, step 204. The choice of an advertisement is inconsequential, as the present embodiment contemplates traversal of the list and the analysis of advertisements contained therein. For the selected advertisement, click rate data corresponding to the advertisement is retrieved, step 205. In accordance with one embodiment, click rate data for an advertisement may comprise the number of times users have clicked on the selected advertisement (or may more generally comprise the recordation of a user interaction with the advertisement, e.g., a mouse over event) in conjunction with the number of impressions for the selected advertisement. Whenever a user clicks on an advertisement hyperlink or the advertisement is shown to the user, data may be returned to the advertisement provider indicating a user has selected the advertisement or viewed the advertisement, respectively. Alternative embodiments may exist wherein additional data is collected in lieu of or in conjunction with the preceding example.

Once the CTR data is retrieved, an exponentially adjusted estimated position-normalized CTR is determined, step 206, using the CTR data as discussed in the disclosure presented with the description of FIG. 1. Upon determination of the exponentially adjusted estimated position-normalized CTR in step 206, a final priority score is determined for the selected advertisement, step 207. In accordance with one embodiment, a priority score is calculated by multiplying the advertiser bid amount by exponentially adjusted estimated position-normalized CTR. After the priority score is determined, the list of advertisements is queried to determine if there are additional advertisements remaining in the list of advertisements that are responsive to the user keywords, step 208. If advertisers remain in the list, program flow returns to step 204 and the process is repeated for the next advertisement.

If priority scores have been computed for advertisements in the list, the advertisements are ranked according to the computed quality scores, step 209. The list of advertisements and priority scores may be ranked via any sorting algorithm known to one of ordinary skill in the art, such as quick sort, merge sort, heap sort, etc.

The ordered and ranked advertisements may be placed within a search result page framework, steps 210-213, or any other content page framework. The highest ranked advertisement is popped from the stack of ranked advertisements, step 210, and a determination is made as to whether a free slot exists on the search results page, step 211. As is known in the art, a search results page may comprise multiple positions for advertisements such as the top of the page, the bottom of the page and the right hand side of the search results, etc. If no slots are available the page has been filled with the advertisements and the advertisements are provided along with the search results, step 214.

If at least one empty slot exists, the selected advertisement is placed within the open slot, step 212. A determination is then made as to whether there are additional advertisements for placement that remain, step 213. In certain cases, more slots than advertisements may exist due to the lack of interest in certain keywords, in which case the slots remain empty when displayed to the user. Alternatively, more advertisements than available slots may exist, in which case only the top ranked advertisements are displayed and lower case advertisements are not be placed on the page. Once all advertisements have been supplied (or all slots filled), the search results and advertisements are provided to the user, step 214.

FIGS. 1 and 2 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for ranking advertisements in an auction-based advertising system, the method comprising:
receiving one or more search queries;
selecting one or more keywords from the one or more search queries;
retrieving one or more bids associated with a given keyword selected from the one or more search queries;
determining a priority score for one or more advertisements, wherein each of the one or more advertisements is associated with a given bid, the priority score determined by taking the product of a position normalized click through rate associated with a given advertisement adjusted by an exponential value and the given bid; and
ranking the one or more advertisements according to the priority score.

2. The method of claim 1, wherein the exponential value is determined using a hierarchal Bayesian model of position-normalized click through rates for the given keyword.

3. The method of claim 1, wherein the exponential value is value between 0 and 1.

4. The method of claim 1, further comprising distributing the one or more advertisements among one or more vacant slots of a search results page according to rank of the one or more advertisements.

5. The method of claim 1, wherein the priority score is determined at runtime.

6. The method of claim 1, wherein the priority score is precalculated.

7. The method of claim 1, wherein the one or more search queries are entered into an HTML form element.

8. A computer readable medium comprising program code that when executed by a programmable processor causes execution of a method for ranking advertisements in an auction-based advertising system, the computer readable media comprising:
program code for receiving one or more search queries;
program code for selecting one or more keywords from the one or more search queries;
program code for retrieving one or more bids associated with a given keyword selected from the one or more search queries;
program code for determining a priority score for one or more advertisements, wherein each of the one or more advertisements is associated with a given bid, the priority determined by taking the product of a position normalized click through rate associated with a given advertisement adjusted by an exponential value and the given bid; and
program code for ranking the one or more advertisements according to the priority score.

9. The computer readable medium of claim 7, wherein the exponential value is determined using program code that determines a hierarchal Bayesian model of position-normalized click through rates for the given keyword.

10. The computer readable medium of claim 7, wherein the exponential value is value between 0 and 1.

11. The computer readable medium of claim 7, further comprising program code for distributing the one or more advertisements among one or more vacant slots of a search results page according to rank of the one or more advertisements.

12. The computer readable medium of claim 7, wherein the priority score is determined at runtime.

13. The computer readable medium of claim 7, wherein the one or more search queries are entered into an HTML form element.

14. A system for ranking advertisements in an auction-based advertising system, the system comprising:
a network;
one or more user devices coupled to the network;
one or more advertiser devices coupled to the network;
a content server coupled to said network, the content server comprising:
a query analyzer operative to receive one or more search queries from the one or more user devices and select one or more keywords from the one or more search queries;
an ad generator operative to generate one or more advertisements corresponding to a search query;
a rank generator operative to retrieve one or more bids associated with a given keyword selected from the one or more search queries, determine a priority score for the one or more advertisements, wherein each of the one or more advertisements is associated with a given bid, the priority score determined by taking the product of a position normalized click through rate associated with a given advertisement adjusted by an exponential value and the given bid and rank the one or more advertisements according to the priority score.

15. The system of claim 13, wherein the exponential value is determined by the rank generator using a hierarchal Bayesian model of position-normalized click through rates for the given keyword.

16. The system of claim 13, wherein the exponential value is value between 0 and 1.

17. The system of claim 13, wherein the content server is further operative to distribute the one or more advertisements among one or more vacant slots of a search results page according to rank of the one or more advertisements.

18. The system of claim 13, wherein the rank generator determines the priority score at runtime.

19. The system of claim 13, wherein the priority score is precalculated.

20. The system of claim 13, wherein one or more user devices coupled to the network comprise an HTML form element operative to receive the one or more search queries.
